(19) United States
(12) Patent Application Publication
(10) Pub. No.: US 2013/0177686 A1
(43) Pub. Date: Jul. 11, 2013

(54) Impregnated nonwoven for degreasing food

(71) Applicant: SONJA IDA SCHLEPPINGHOFF, Koeln (DE)

(72) Inventors: Christof Maria Schleppinghoff, Koeln (DE); Lothar Hentz, Rosendahl (DE)

(73) Assignee: Sonja Ida Schleppinghoff, Koeln (DE)

(21) Appl. No.: 13/711,754

(22) Filed: Dec. 12, 2012

Related U.S. Application Data
(60) Provisional application No. 61/569,470, filed on Dec. 12, 2011.

(30) Foreign Application Priority Data
Dec. 12, 2011 (EP) 11193100.2

(51) Int. Cl. A23L 1/015; B01J 20/32; B01J 20/26

(52) U.S. Cl. CPC A23L 1/0156; B01J 20/26; B01J 20/3214
USPC 426/417; 502/401; 502/402; 502/404

(57) ABSTRACT

Various embodiments relate to an impregnated nonwoven for degreasing food, to a process for degreasing food and to a process for manufacturing the impregnated nonwoven.

### CROSS-REFERENCE TO RELATED APPLICATIONS

This application claims priority to the U.S. Provisional Application No. 61/569,470, filed on Dec. 12, 2011, and European Patent Application 11 193 100.2, also filed on Dec. 12, 2011, both of which are hereby incorporated by reference.

### FIELD

The present invention relates to an impregnated nonwoven for degreasing food, to a process for degreasing food and to a process for manufacturing the impregnated nonwoven.

### BACKGROUND

So far, several technical solutions have been proposed to be used in the kitchen for removal of excess oil or fat from food, especially from freshly roasted, boiled or fried food. So far, these solutions of the prior art relied on the particular construction of the products or on the physical properties of the fibers.

German Patent Application No. DE202011100894U1 describes a nonwoven for degreasing food, which has not been impregnated.

U.S. Pat. No. 6,152,025 describes a fat collection structure and method.

Japanese Patent Application no. JP2002346380 describes an oil adsorption sheet.

The problem to be solved in the present invention is to provide an improved nonwoven for degreasing food overcoming the shortcomings of the prior art.

### SUMMARY

A first embodiment includes an impregnated nonwoven for degreasing food, including at least a nonwoven and an impregnating composition, wherein the impregnating composition includes only food grade components and at least an oleophilic substance and an emulsifier.

A second embodiment includes a process for degreasing food, wherein the food is contacted with the impregnated nonwoven according to the present invention.

A third embodiment includes a process for manufacturing the impregnated nonwoven according to the present invention, wherein the process comprises at least the following processes:
a. contacting a thermoplastic nonwoven with a water based emulsion of the oleophilic substance comprising the emulsifier, and
b. drying the thermoplastic nonwoven.

### DETAILED DESCRIPTION

The problem according to the present invention is solved in a first embodiment by an impregnated nonwoven for degreasing food, including at least a nonwoven and an impregnating composition, wherein the impregnating composition includes only food grade components and at least an oleophilic substance and an emulsifier.

The term “food grade” is defined as according to European Commission (EC) Regulation No 178/2002. In particular “food grade” according to the present invention means the following: all components must be fit for human consumption and according to scientific knowledge all components must not be injurious to health and must be safe. Also, the intended use (in foods) of all components must not represent a health hazard to consumers.

In the conventional embodiments, the impregnation has been seen as disadvantageous due to food regulations. However, the inventors have discovered, that even with purely food grade components, an impregnation can improve the oil take up significantly.

In various embodiments, the oleophilic substance is selected from wax and derivatives, silicone and derivatives, and mixtures thereof.

In various particular embodiments, the oleophilic wax may be a paraffin wax, especially comprising a salt of aluminium.

In various particular embodiments, the oleophilic substance has a kinematic viscosity in the range from 50 to 500 mm²/s. The viscosity can be measured according to ASTM D 445 at 20° C. and atmospheric pressure.

In some particular embodiments, the emulsifier is selected from thickeners, polysaccharides, surfactants, polysorbate 20, ceteareth 20 or mixtures thereof.

The surfactant according to the present invention may be selected from, for example, calcium lignin sulfonates, copolymer condensates of ethylene oxide and propylene oxide, polyglyceryl-3 stearate or polyglyceryl-5 dioleaete.

In various particular embodiments, the ratio of emulsifier to oleophilic substance is in a range from 1:1 to 300,000, and in particular cases is from 1:10 to 1:2000.

In some particular embodiments, the impregnated nonwoven comprises 1 to 30 wt. % impregnating composition.

In various particular embodiments, the polysaccharide has a mannose backbone. The polysaccharides may be a galactomannan in some of these embodiments. In particular, the ratio of mannose to galactose may be between 3:1 to 5:1.

In some particular cases, the thermoplastic nonwoven is spunbond, meltblown or a combination thereof. In particular, the thermoplastic nonwoven may be an SMS (spunbond-meltblown-spunbond) nonwoven. This particular type of nonwoven has been discovered by the inventors to be very suitable for the particular applications described herein.

In various particular embodiments, the material of the nonwoven is selected from the group consisting of polypropylene, polyethylene, polyimide, polyester or mixtures thereof. One preferred material is isotactic polypropylene due to its high melting point.

In various cases, the melting point of the material for the nonwoven is above 130° C. This can lead to less thermoplastic material melting during contact with the food than in materials with lower melting points.

In some embodiments, the unit weight per area is in a range from 50 to 300 g/m², in particular in the range from 100 to 200 g/m². The unit weight per area for a spunbond layer may be in a range from 5 to 30 g/m², in particular in a range from 10 to 20 g/m². The unit weight per area for a meltblown layer may be in a range from 50 to 300 g/m², in particular in a range from 100 to 200 g/m².

The bonding between layers may be facilitated by ultrasonic welding or by a cut & seal process in many cases.

The thickness of the impregnated nonwoven according to the present invention may be in a range of from 0.5 to 3 mm. The largest diameter of the impregnated nonwoven according to the present invention may be in a range of from 10 to 50 cm. The impregnated nonwoven according to the present invention may have a shape selected from oval, square, circle, rectangle, or special shapes like flower-shape, soccer-ball-shape, star-shape, goose-shape or fish-shape.

The overall water content of the impregnated nonwoven according to the present invention may be below 5 wt. %, in particular below 1 wt. %.

The problem according to the present invention is solved by another embodiment by a process for degreasing food, wherein the food is contacted with the impregnated nonwoven according to the present invention.

In various particular embodiments, the duration of the contact is in a range from 1 to 60 seconds. According to the process of embodiments of the invention, the impregnated nonwoven according to the present invention is removed from the food after contact. The impregnated nonwoven according to the present invention may be used one-way or several times. The impregnated nonwoven according to the present invention may be pressed onto the food while contacting, or vice versa.

The problem according to the present invention is solved by another embodiment by a process for manufacturing the impregnated nonwoven according to the present invention, wherein the process includes at least the following processes:
a. contacting a thermoplastic nonwoven with a water based emulsion of the oleophilic substance comprising the emulsifier, and
b. drying the thermoplastic nonwoven.

Contacting in the sense of the application can include (e.g., preferably includes): spraying, immersion, foulard processing, lacquering and painting.

In various particular embodiments, the nonwoven is contacted by soaking or immersion. In some cases, the contacted nonwoven is squeezed until the weight of the contacted nonwoven is in a range of from 110 to 200% of the non-contacted nonwoven.

In various particular embodiments, the drying temperature is in a range of from 120 to 150° C. The duration of the drying step may preferably be in a range of from 30 to 300 s.

### EXAMPLE

The following non-limiting example is included for the purposes of illustrating the various aspects of the invention:

A composition 1 comprising 30 g of dimethicone (350 cSt.), 0.4 g polyglyceryl-3 stearate as an emulsifier and 69.6 g water was prepared and stirred until an emulsion was received.

A composition 2 comprising 30 g liquid paraffine, 0.4 g polyglyceryl-3 stearate as an emulsifier and 69.6 g water was prepared and stirred until an emulsion was received.

Three pieces of square-shaped SMS nonwoven with an edge length of 10 cm were prepared by a cut & seal process. The unit weight per area for the spunbond layers was 20 g/m² each. The unit weight per area for the meltblown layer was 200 g/m². The thickness of the overall nonwoven was 2 mm. The material of all layers was isotactic polypropylene.

Two of the pieces were immersed and soaked in compositions 1 and 2, respectively. After soaking, the pieces were squeezed until the weight was 330 g/m².

The resulting pieces were dried at 130° C. for 60 s. The water content was 0.8 wt. %.

After this, the impregnated pieces and the non-treated piece of nonwoven were immersed in olive oil for 60 s. After that the pieces were removed and drained until no further drops of olive oil were dropping off the respective pieces.

The results were as follows:

| | Composition 1 | Composition 2 | Not treated |
|---|---|---|---|
| Oil absorption 1 | 825 | 1132 | 750 |
| Oil absorption 2 | 787 | 866 | 731 |

Oil absorption is given in wt. % of the original dried piece.

Oil absorption 1 was oil at room temperature.

Oil absorption 2 was oil at 60° C.

Various embodiments of the invention can be characterised as:

Embodiment 1: Impregnated nonwoven for degreasing food, comprising at least a nonwoven and an impregnating composition, wherein the impregnating composition comprises only food grade components and at least an oleophilic substance and an emulsifier.

Embodiment 2: a nonwoven according to embodiment 1, wherein the oleophilic substance is selected from wax and derivatives, silicone and derivatives, and mixtures thereof.

Embodiment 3: a nonwoven according to any one of embodiments 1 and 2, wherein the emulsifier is selected from thickeners, polysaccharides, surfactants, polysorbate 20, ceteareth 20 or mixtures thereof.

Embodiment 4: a nonwoven according to any one of embodiments 1-3, wherein the ratio of emulsifier to oleophilic substance is in a range from 1:1 to 300,000, in particular from 1:10 to 1:2000.

Embodiment 5: a nonwoven according to any one of embodiments 1-4, wherein the impregnated nonwoven comprises 1 to 30 wt. % impregnating composition.

Embodiment 6: a nonwoven according to any one of embodiments 3-5, wherein the surfactant is selected from calcium lignin sulfonate or copolymer condesates of ethylene oxide and propylene oxide.

Embodiment 7: a nonwoven according to any one of embodiments 3-5, wherein the polysaccharide has a mannose backbone.

Embodiment 8: a nonwoven according to any one of embodiments 1-7, wherein the thermoplastic nonwoven is spunbond, meltblown or a combination thereof.

Embodiment 9: a process for degreasing food, wherein the food is contacted with the impregnated nonwoven according to any of embodiments 1-8.

Embodiment 10: a process for manufacturing the impregnated nonwoven according to any of embodiments 1-8, wherein in comprises at least the following steps:

contacting a thermoplastic nonwoven with a water based emulsion of the oleophilic substance comprising the emulsifier, and

drying the thermoplastic nonwoven.

We claim:

1. An impregnated nonwoven for degreasing food, the impregnated nonwoven comprising at least a nonwoven and an impregnating composition, wherein the impregnating composition comprises only food grade components and at least an oleophilic substance and an emulsifier.

2. The nonwoven according to claim 1, wherein the oleophilic substance is selected from wax and derivatives, silicone and derivatives, and mixtures thereof.

3. The nonwoven according to claim 2, wherein the emulsifier is selected from thickeners, polysaccharides, surfactants, polysorbate 20, ceteareth 20 or mixtures thereof.

4. The nonwoven according to claim 3, wherein the ratio of emulsifier to oleophilic substance is in a range from 1:1 to 300,000.

5. The nonwoven according to claim 1, wherein the impregnated nonwoven comprises 1 to 30 wt. % impregnating composition.

6. The nonwoven according to claim 3, wherein the surfactant is selected from calcium lignin sulfonate or copolymer condesates of ethylene oxide and propylene oxide.

7. The nonwoven according to claim 3, wherein the polysaccharide has a mannose backbone.

8. The nonwoven according to claim 1, wherein the nonwoven is spunbond, meltblown or a combination thereof.

9. A process for degreasing food, wherein the food is contacted with the impregnated nonwoven according to claim 1.

10. A process for manufacturing the impregnated nonwoven according to claim 1, wherein the process comprises at least the following processes:
a. contacting a thermoplastic nonwoven with a water based emulsion of the oleophilic substance comprising the emulsifier, and
b. drying the thermoplastic nonwoven.

11. The nonwoven according to claim 1, wherein the emulsifier is selected from thickeners, polysaccharides, surfactants, polysorbate 20, ceteareth 20 or mixtures thereof.

12. The nonwoven according to claim 2, wherein the ratio of emulsifier to oleophilic substance is in a range from 1:1 to 300,000,

13. The nonwoven according to claim 12, wherein the ratio of emulsifier to oleophilic substance is in a range from 1:10 to 1:2000.

14. The nonwoven according to claim 1, wherein the ratio of emulsifier to oleophilic substance is in a range from 1:1 to 300,000.

15. The nonwoven according to claim 14, wherein the ratio of emulsifier to oleophilic substance is in a range from 1:10 to 1:2000.

16. The nonwoven according to claim 4, wherein the ratio of emulsifier to oleophilic substance is in a range from 1:10 to 1:2000.

17. The nonwoven according to claim 4, wherein the impregnated nonwoven comprises 1 to 30 wt. % impregnating composition.

18. The nonwoven according to claim 4, wherein the surfactant is selected from calcium lignin sulfonate or copolymer condesates of ethylene oxide and propylene oxide.

19. The nonwoven according to claim 5, wherein the surfactant is selected from calcium lignin sulfonate or copolymer condesates of ethylene oxide and propylene oxide.

20. The nonwoven according to claim 4, wherein the polysaccharide has a mannose backbone.
